(19) United States
(12) Patent Application Publication
(10) Pub. No.: US 2002/0076480 A1
(43) Pub. Date: Jun. 20, 2002

(54) Low cost step tunable light source

(76) Inventors: Yung-Chieh Hsieh, San Jose, CA (US); Alireza Badakhshan, Dublin, CA (US)

Correspondence Address: Bruce H. Johnsonbaugh, Eckhoff, Hoppe, Slick, Mitchell & Anderson, 333 Market Street, Suite 3125, San Francisco, CA, 94105, US

(21) Appl. No.: 09/912,747

(22) Filed: Jul. 23, 2001

Related U.S. Application Data
(63) Continuation of application No. 09/738,218, filed on Dec. 15, 2000.

(51) Int. Cl. B05D 1/00

(52) U.S. Cl. 427/8; 118/668

(57) ABSTRACT

The invention is a tunable light source. Techniques for multiplexing various wavelengths into one fiber are provided. A thin film deposition optical monitoring system is provided that utilizes a multiplexer according to the present invention. Light from a multiplexed light source is passed through a fiber optic and emerges from the fiber tip. The light beam is collimated and passes through the substrate where a lens then focuses the transmitted light into a photo-detector. After signal processing, information is sent to the deposition flux source controller to control the deposition rate, coating material and whether deposition should be terminated. An advantage of the present invention over tunable lasers is realized in the low cost of the present invention.

### CROSS REFERENCE TO RELATED APPLICATION

This application is a continuation of patent application Ser. No. 09/738,218 filed Dec. 15, 2000 and entitled LOW COST STEP TUNABLE LIGHT SOURCE.

### BACKGROUND OF THE INVENTION

1. Field of the Invention

The present invention relates to thin film deposition, and more specifically, it relates to techniques for monitoring thin film deposition processes.

2. Description of Related Art

Tunable lasers are widely used to monitor thin film deposition processes, especially in growing filters for use in wavelength division multiplexers (WDMs). In WDMs, various channels of light with different wavelengths are multiplexed (MUX) into the same optical fiber, or the light from a single fiber containing various wavelengths is separated or demultiplexed (DE-MUX) into different channels. Typically, the channel spacing is on the order of a few nanometers to a fraction of a nanometer. Filters in MUX and DE-MUX devices are designed to pass light from one specific channel and reflect light from all other channels. For most applications, there are hundreds of layers for each filter and the thickness of each layer has to be precisely controlled, resulting in the necessity of optically monitoring the film thickness during deposition.

Since the central wavelength of each filter varies from channel to channel, the monitor optics should be able to provide wavelengths for all of the channels. Tunable lasers thus play an important role for monitoring the deposition process.

FIG. 1 shows a typical prior art optical monitoring system for thin film deposition Light 10 from a tunable light source 12 is passed through a fiber optic 14 and emerges from fiber tip 16. Light 10 is then collimated by lens 18 and then passes through the substrate 20. The transmissivity of substrate 20 is a function of the film structure deposited from deposition flux source controller 22 onto substrate 20. To obtain a good monitoring signal, the backside of substrate 20 is usually anti-reflection coated. Lens 24 is used to focus the transmitted light into photo-detector 26. After signal processing (28), information is sent to the deposition flux source controller 22 to control the deposition rate, coating material and whether deposition should be terminated. One drawback of this approach is that the tunable laser is very expensive.

It is desirable to provide a low cost alternative to the conventional tunable laser for monitoring thin film deposition processes.

### SUMMARY OF THE INVENTION

It is an object of the present invention to provide a step tunable laser system for monitoring thin film deposition processes.

Other objects will be apparent to those skilled in the art based on the disclosure herein.

The invention is a tunable light source. One embodiment of the invention is used as an optical monitor for a thin film deposition process. An example provides four lasers, each having a discrete wavelength of interest that is coupled by multiplexer into a fiber. Any of the four wavelengths can be selected as a light source for monitoring the film deposition process.

Tunability of each laser is provided by temperature control. For example, in a vertical cavity surface emitting laser (VCSEL), the temperature coefficient is about 60×10⁻¹² meters/° C. for the wavelength around 800 nm. By controlling temperature from 0 to 60 degrees, the tuning range is about 3.6 nm. If the wavelength spacing of each laser within the device is less than 3.6 nm, by adding temperature control to each laser, the lasers have some overlap of wavelengths, resulting in light source that will perform exactly the same as a continuous tunable laser. In one embodiment, the diode lasers are located on a circuit board.

Technique for multiplexing various wavelengths into one fiber are provided An embodiment is described where a multiplexer couples four lasers of different wavelength into a fiber; however, this invention is not limited to the coupling of four lasers, but may be altered to multiplex any desired number of laser wavelength combinations.

A thin film deposition optical monitoring system is provided that utilizes a multiplexer according to the present invention. Light from a multiplexed light source is passed through a fiber optic and emerges from the fiber tip. Alternately, the multiplexer can be omitted, and light from each discrete light source may be individually and alternately placed on the common optical path. The light beam is collimated and passes through the substrate. A lens focuses the transmitted light into a photo-detector. After signal processing, information is sent to the deposition flux source controller to control the deposition rate, coating material and whether deposition should be terminated.

An advantage of the present invention over tunable lasers is realized in the low cost of the present invention. This is a result of the fact that each laser has its own fixed wavelength. The cost of an assembly combining many of these lasers is less than a single laser of tunable capability. The present invention is also advantageous because in some cases, the tunable laser is not available or the tuning range may not be large enough to cover all the wavelengths of interest. The concept of step tunable light source is a solution to fit the requirement.

### BRIEF DESCRIPTION OF THE DRAWINGS

FIG. 1 shows a typical prior art optical monitoring system for thin film deposition.

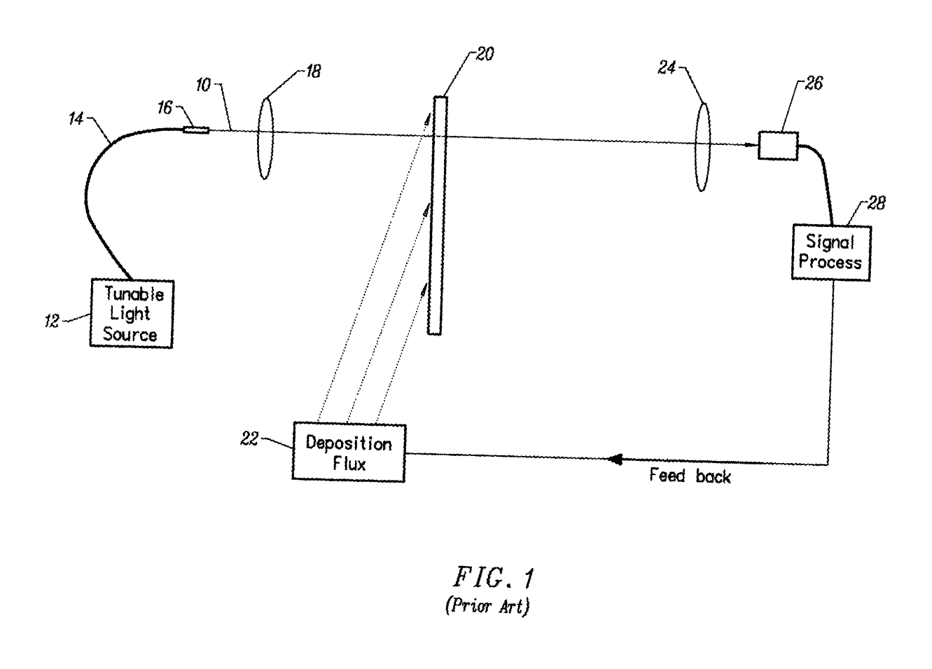

FIG. 2 shows an embodiment of a 4-step tunable light source according to the present invention.

FIG. 3 is one technique for multiplexing various wavelengths into one fiber.

FIG. 4 shows a 4-channel single-mode wavelength division multiplexer.

FIG. 5 shows a thin film deposition optical monitoring system that utilizes a multiplexer according to the present invention.

### DETAILED DESCRIPTION OF THE INVENTION

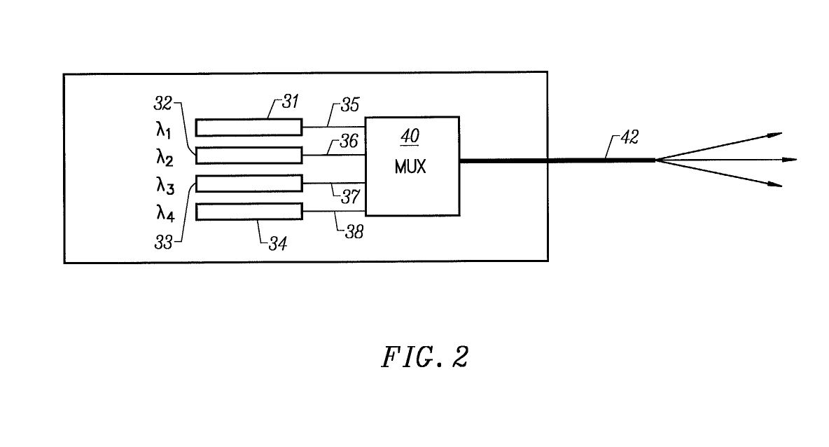

FIG. 2 shows an embodiment of a 4-step tunable light source according to the present invention. Basically, four lasers (31-34) with four wavelengths (35-38) of interest are coupled by multiplexer 40 into a fiber 42. One can select any of the four wavelengths as a light source for monitoring the film deposition. In a practical system, one can have any number of wavelengths. Alternately, the system of FIG. 2 may omit the multiplexer 40, in which case the individual fibers (35-38) would be connected directly to fiber 42, or alternately positioned in the same location to emit light onto a common optical path. Since the wavelengths used in a wavelength division multiplexer (WDM) communication system are distributed discretely, the step tunable light source performs as well as a conventional continuous tunable laser.

For laser diodes, the output wavelength of each laser is proportional to the operation temperature of the laser. Therefore, the tunability of each laser can be enhanced by temperature control. For instance, for a vertical cavity surface emitting laser (VCSEL), the temperature coefficient is about 60×10⁻¹² meters/° C. for the wavelength around 800 nm. By controlling temperature from 0 to 60 degrees, the tuning range is about 3.6 nm. If the wavelength spacing of each laser within the device (e.g., as shown in FIG. 2) is less than 3.6 nm, by adding temperature control to each laser, the lasers have some overlap of wavelengths, resulting in light source that will perform exactly the same as a continuous tunable laser. In one embodiment, the diode lasers are located on a circuit board.

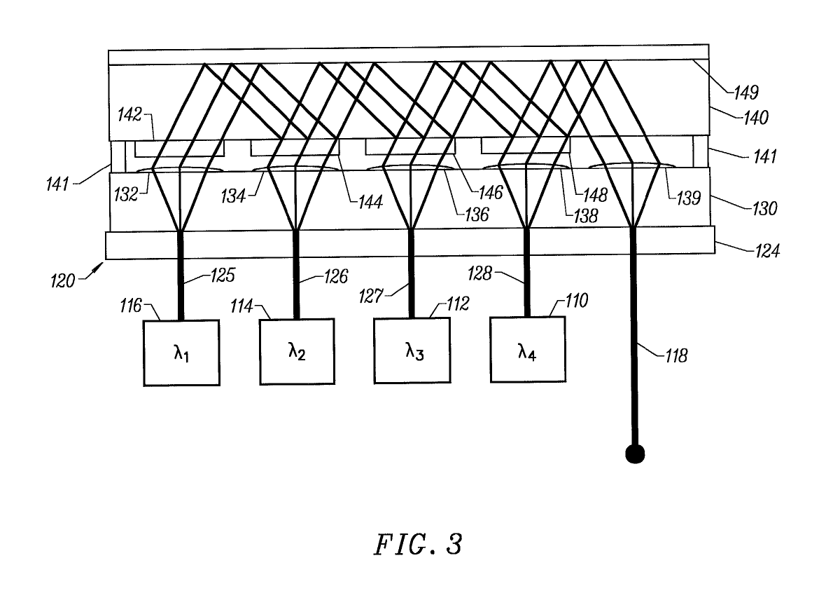

FIG. 3 is one technique for multiplexing various wavelengths into one fiber. Other methods and apparatuses for multiplexing are described in U.S. patent application Ser. No. 09/568,220, titled “Cost-Effective Wavelength Division Multiplexer And Demultiplexer” and U.S. patent application Ser. No. 09/656,514, titled “Integrated Filter Array For Use With A Wavelength Division Multiplexer/Demultiplexer,” both incorporated herein by reference. Other methods for multiplexing are known in the art. The multiplexers described in the present application and in the incorporated applications, as well as those known in the art, derive a benefit (e.g., enhanced stabilization) from including the power monitoring techniques described in U.S. patent application Ser. No. 09690,264, titled “Real-Time Monitoring Of Laser Power In Fiber-Optic Communication Systems” incorporated herein by reference.

FIG. 3 shows a schematic of an embodiment the multiplexer of the present invention. Although this embodiment couples four lasers 110, 112,114 and 116 of different wavelength into a fiber 118, this invention is not limited to the coupling of four lasers, but may be altered to multiplex any desired number of laser wavelength combinations. The whole device consists of three different modules. They are a fiber array 120, a lens array 130 and filter array/reflector 140. The fiber array is also generically referred to as an input/output array. The fiber array is connected to the light sources (110, 112, 114 and 116), which optimally are fiber pig-tailed semiconductor lasers. (A specific embodiment utilizes VCSELs.) In this way, the light source can be repeatably and accurately placed to the right position in reference to the lens array 130.

The fiber array 120 is made by first drilling holes through a substrate 124, such as a silicon substrate 124, and then each fiber (125, 126, 127, 128 and 118) is inserted into a separate hole and bonded to the substrate. The input lenses 132, 134, 136 and 138 and the output lens 139 on the lens array 130 could be either diffractive or refractive lenses. The input lenses are used to collimate the beams such that light will travel from them at an angle and will zigzag between the reflector 149 and the filter array, which comprises filters 142, 144, 146 and 148 of reflector/filter array 140. Output lens 139 is used to focus the beams from each different laser for coupling into fiber 118.

Various narrow-band filters make up the filter array. Each filter 142, 144, 146 and 148 passes the light of one specific wavelength and reflects the light of the other wavelengths. In one embodiment, lasers 110, 112, 114 and 116 are fiber pigtailed diode lasers that produce wavelengths of 800.0 nm, 803.4 nm, 806.8 nm and 810.2 nm respectively.

The above three modules are built independently. Each light source has to be aligned to its corresponding lens to the accuracy of micrometers. Since the fiber array 120 and lens array 130 are made by standard photolithographic technology, the spacing between elements can be very precisely set (in tens of nanometers). After all three modules are made, a standard wafer bonding technique is used to bond them to each other. If desired, one could actively align the fiber optics array to the lens array prior to bonding. A spacer or post 141 may be placed at the outer periphery between the lens array and the filter array/reflector and the bonding material may be applied to the spacer. Alternately, the lens array may be bonded to the filter array/reflector by abutting the lenses to the filters and bonding the edges of the device. Another alternate method of bonding the lens array to the filter array/reflector would be to place the two pieces in a fixture at a desired separation, and to fill the space between the two pieces with either an index matching adhesive, or a low index adhesive. After all the three arrays are bonded to each other, they may be diced into individual micro-optical devices.

As an alternate to the fiber array in a single piece of substrate, two opposing V-grooves may support the fiber. Opposing V-grooves in silicon substrates can sandwich the fiber to precisely register its position. The V-groove can be made by a standard photolithographic process. Methods for making the v-grooves described above and other types of v-groove fiber mounts usable in the present invention are described in U.S. Pat. No. 5,692,089 titled “Multiple Fiber Positioner For Optical Fiber Connection” and U.S. Pat. No. 4,511,207 titled “Fiber Optic Data Distributor”, the disclosures both of which are incorporated herein by reference.

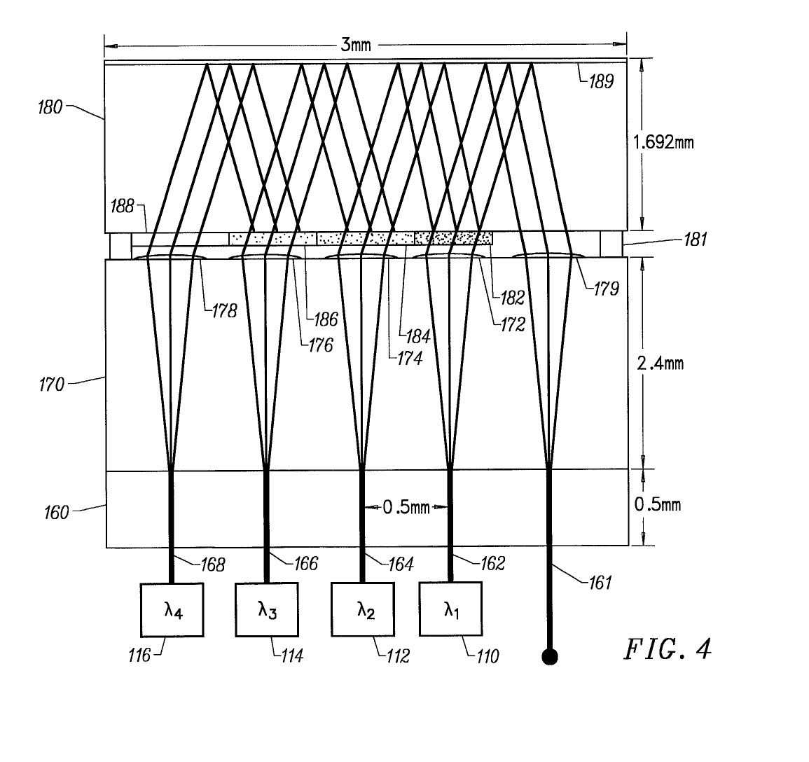

FIG. 4 shows a 4-channel single-mode wavelength division multiplexer. In this design, there are three independent modules, including a fiber array 160, a lens array 170 and a filter array/reflector 180. In order to obtain high precision position control, diffraction lenses 172, 174, 176, 178 and 179 are used. In this embodiment, lasers 110, 112, 114 and 116 are fiber pigtailed diode lasers that produce wavelengths of 800.0 nm, 803.4 nm, 806.8 nm and 810.2 nm respectively. Lasers 110, 112, 114 and 116 are connected via the fiber pigtail to fibers 162, 164, 166 and 168, respectively, which have each been inserted and bonded into holes in the substrate of fiber array 160. In this embodiment, fiber 162, 164, 166 and 168 are separated by 0.5 mm and the substrate is 0.5 mm thick by 3 mm wide.

In one embodiment that corresponds to the structure shown in FIG. 4, the lens array 170 is 2.4 mm thick and 3 mm wide. The diffractive lenses 172, 174, 176, 178 and 179 are fabricated through conventional photolithography techniques so that the optical axis or lens center of each lens will be aligned with fiber 162, 164, 166, 168 and 161 respectively when lens array 170 is aligned with fiber array 160. Such conventional photolithography techniques are known in the art and some examples are described in U S. Pat. No. 5,871,888 titled “Method Of Forming Multiple-Layer Microlenses And Use Thereof, ” U.S. Pat. No. 5,605,783 titled “Pattern Transfer Techniques For Fabrication Of Lenslet Arrays For Solid State Imagers” and U.S. Pat. No. 5,977,535 titled “Light Sensing Device Having An Array Of Photosensitive Elements Coincident With An Array Of Lens Formed On An Optically Transmissive Material”, the disclosures of which three patents are incorporated herein by reference.

The filter array/reflector combination 180, shown in FIG. 4, comprises a bandpass filter 182, 184, 186 and 188 associated with each lens 172, 174, 176 and 178 respectively. Each bandpass filter is chosen to pass the wavelength of light that is collimated by its associated lens, and is reflective at the wavelengths collimated by the other lenses of lens array 170. The reflective coating 189 is selected to be broadband or to at least be highly reflective over the range of selected wavelengths (in this case 800.0 nm to 810.2 nm). The filter array/reflector, in this embodiment, is made of fused silica and is 1.692 mm by 3 mm. The reflective coating may be formed onto the fused silica substrate by conventional methods such as sputter deposition, gaseous diffusion or other known methods. Lens array 170 and filter array/reflector 180 are bonded together with posts 181. The length of each post 181, in the shown embodiment, is set at about 200 μm to 300 μm.

The operation of the invention can be understood with reference to FIG. 4. Laser light from diode laser 116 is coupled into fiber 168 from which it diverges and is collimated by lens 178, and propagates therefrom at an angle, to pass through filter 188 and then reflects from reflective coating or surface 189 to reflect in a zig-zag pattern from filter 186 to reflector 189 to filter 184 to reflector 189 to filter 182 and to reflector 189 from which the beam passes through lens 179 and is focused and collected by input/output fiber 161. Laser light from each of the remaining diode lasers 114, 112 and 110 follows a similar path through its respective fiber and lens to propagate substantially collinearly with the light beam from diode laser 116 and to eventually be focused by lens 179 into fiber 161.

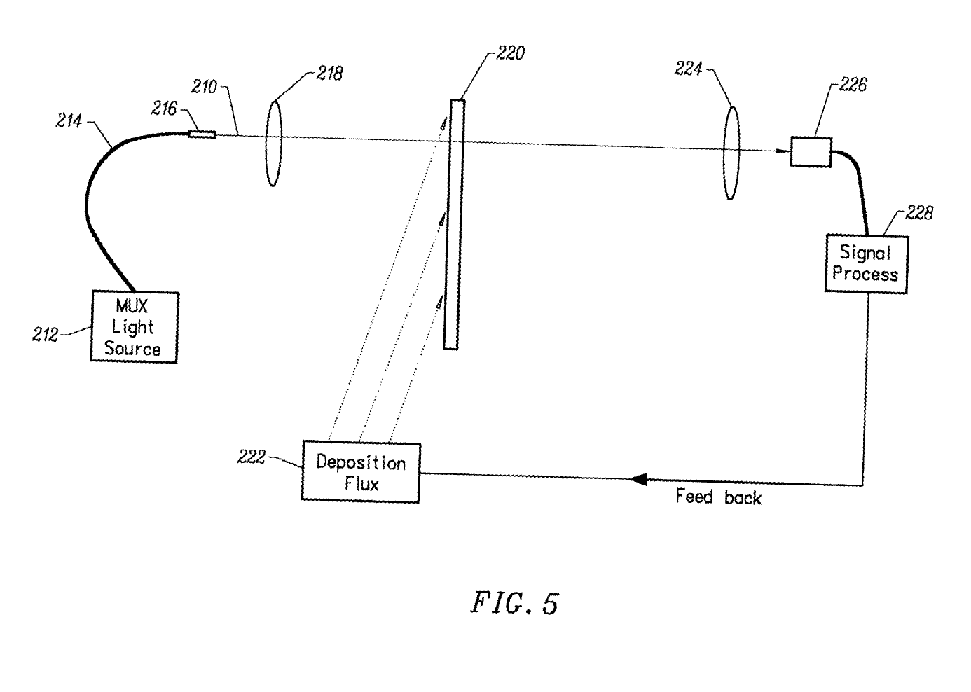

FIG. 5 shows a thin film deposition optical monitoring system that utilizes a multiplexer according to the present invention. Light 210 from a multiplexed light source 212 is passed through a fiber optic 214 and emerges from fiber tip 216. Alternately, the multiplexer can be omitted, as in FIG. 2, and light from each discrete light source may be individually and alternately placed on the common optical path coincident with light beam 210. Light beam 210 is then collimated by lens 218 and then passes through the substrate 220. Lens 224 is used to focus the transmitted light into photo-detector 226. The sum of the response time of the detector 226, the signal processing 228 and the deposition controller must be fast enough (preferably much faster) to detect changes in the deposition rate. After signal processing (228), information is sent to the deposition flux source controller 222 to control the deposition rate, coating material and whether deposition should be terminated. The operation of example signal processors, including software, usable in the present invention are known in the art and are described by Macleod, H. A. (1969) in “Thin-Film Optical Filters,” American Elsevier, New York, incorporated herein by reference.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. An optical monitoring system, comprising:
a plurality of light sources, wherein each light source of said plurality of light sources produces a discrete wavelength;
means for placing each said discrete wavelength on a common optical path;
means for positioning a substrate in said common optical path, wherein each said discrete wavelength will pass through said substrate to produce a measurement beam;
a detector operatively positioned to detect said measurement beam;
a signal processor connected to said detector; and
a coating deposition system operatively positioned to coat material onto said substrate under test, wherein said coating deposition system is connected to and controlled by said signal processor.

2. The optical monitoring system of claim 1, wherein at least one of light source of said plurality of light sources comprises a laser diode.

3. The optical monitoring system of claim 1, wherein said plurality of light sources comprises a plurality of laser diodes.

4. The optical monitoring system of claim 2, wherein said laser diode comprises a vertical cavity surface emitting laser.

5. The optical monitoring system of claim 1, further comprising a temperature controller, wherein said plurality of light sources are temperature controlled by said temperature controller.

6. The optical monitoring system of claim 1, further comprising a temperature controller, wherein at least one light source of said plurality of light sources is temperature controlled by said temperature controller.

7. The optical monitoring system of claim 2, further comprising a circuit board, wherein said plurality of laser diodes are fixedly and operatively attached to said circuit board.

8. The optical monitoring system of claim 1, wherein each of said detector, said signal processor and said coating deposition system comprises a response time, wherein the sum of the response time of said detector, said signal processor and said coating deposition system is fast enough to detect changes in the deposition rate produced by said coating deposition system on said substrate.

9. The optical monitoring system of claim 1, wherein said means for placing each said discrete wavelength on a common optical path comprises a wavelength division multiplexer (WDMUX).

10. The optical monitoring system of claim 9, wherein said WDMUX comprises.
a first substrate comprising means for providing light to and receiving light from said apparatus;
a second substrate comprising at least one lens operatively connected thereto; and
a third substrate comprising at least one bandpass filter operatively connected thereto, wherein said third substrate further comprises means for reflecting said light, wherein said first substrate and said second substrate and said third substrate are fixedly and operatively connected such that said apparatus operates as an optical wavelength multiplexer.

11. The optical monitoring system of claim 9, wherein said WDMUX comprises:
an input/output array, comprising a first substrate and at least one fiber optic bonded to said first substrate, to produce an input/output array having a first side and an second side;
a lens array, comprising a second substrate having a lens mounting surface and a surface for placement adjacent said second side of said input/output array, said lens array including a plurality of first lenses and an input/output lens, wherein said plurality of first lenses and said input/output lens are adherent to said lens mounting surface, wherein said second substrate is operatively positioned with respect to said first substrate such that said input/output array is operatively aligned to said lens array, wherein said second side of said fiber array is bonded to said lens array at said surface for placement adjacent said second side of said fiber array; and
a filter array/reflector combination comprising a third substrate with a filter side having at least one optical filter, said filter array/reflector combination further comprising a reflective coating opposite said filter side, wherein said third substrate is operatively positioned with respect to said second substrate such that said lens array is operatively aligned with said filter array/reflector, wherein said first substrate and said second substrate and said third substrate are fixedly and operatively connected to operate as an optical wavelength multiplexer.

12. The optical monitoring system of claim 9, wherein said WDMUX comprises:
an integrated filter assembly (IFA), comprising a plurality of optically transparent substrates connected together to form a stack, wherein said stack comprises two outer interfaces and at least one inner interface, wherein at least one outer interface of said two outer interfaces comprises a junction of a substrate of said plurality of optically transparent substrates and the medium within which said stack is placed, wherein said at least one inner interface comprises a junction of two adjacent substrates of said stack, wherein said at least one inner interface comprises a reflective coating, wherein each reflective coating is reflective at a different wavelength;
a first wavelength division multiplexer substrate comprising means for providing light to and receiving light from said IFA; and
a second WDM substrate comprising at least one lens operatively connected thereto, wherein said stack and said first WDM/D substrate and said second WDM/D substrate are fixedly and operatively connected and optically aligned to provide an optical wavelength multiplexer.

13. The optical monitoring system of claim 1, wherein each light source of said plurality of light sources comprises a system for monitoring the power of said light source.

14. The optical monitoring system of claim 13, wherein said system for monitoring the power of said light source comprises an optic having an odd-curvature designed to direct light from said light source onto a light source monitoring detector.

15. A method for monitoring coating deposition onto a substrate, comprising:
producing a plurality of discrete wavelengths;
aligning at least one wavelength of said plurality of discrete wavelengths onto a common optical path;
placing a substrate under test into said common path, wherein said at least one wavelength will pass through said substrate to produce a measurement beam;
detecting said measurement beam with a detector; and
coating material onto said substrate with a coating deposition system controlled by a signal processor operatively connected to said detector.

16. The method of claim 1, wherein the step of producing a plurality of discrete wavelengths is carried out with at least one laser diode.

17. The method of claim 15, wherein the step of producing a plurality of discrete wavelengths is carried out with at least one vertical cavity surface emitting laser.

18. The method of claim 15, further comprising controlling the temperature of said plurality of light sources.

19. The method of claim 15, further comprising controlling the temperature of at least one light source of said plurality of light sources.

20. The method of claim 15, wherein the step of placing a substrate under test into said common path is carried out with a wavelength division multiplexer.
